(19) United States
(12) Patent Application Publication
(10) Pub. No.: US 2024/0430240 A1
(43) Pub. Date: Dec. 26, 2024

(54) ELECTRICAL COMPONENTS FOR SCIENCE, TECHNOLOGY, ENGINEERING, AND MATH CONSTRUCTION SYSTEMS

(71) Applicant: SPHERO, INC., Boulder, CO (US)

(72) Inventors: Jeffrey Wiencrot, IV, Denver, CO (US); Charles Michael Wensel, Frisco, TX (US); Paul David Copioli, Rockwall, TX (US); Arthur Philip Dutra, Elk Grove, CA (US)

(73) Assignee: SPHERO, INC., Boulder, CO (US)

(21) Appl. No.: 18/751,324

(22) Filed: Jun. 23, 2024

Related U.S. Application Data
(60) Provisional application No. 63/510,103, filed on Jun. 23, 2023.

(51) Int. Cl. H04L 9/40; H04L 69/24

(52) U.S. Cl. CPC H04L 63/0281; H04L 69/24

(57) ABSTRACT

The present disclosure relates to a digital electrical system for STEM construction system. In examples, the STEM construction system may consist of one or more electrical components and various structural elements to support the electrical components. The system may have a power source (e.g., battery) component with a plurality of connection pins, wherein one of the plurality of connection pins is a sensing pin used for sensing other power sources and communicating the present status of the power source component. The digital electrical system may utilize a proxy communication method where one electrical component can function as a proxy for other components in the system by collecting information on other components in the system and transmitting that to requesting components. Alternatively, a standard and coding communication methods may be used. Normalized unitless data may be communicated throughout the system.

### CROSS-REFERENCE TO RELATED APPLICATIONSI

This application claims priority to U.S. Provisional Application No. 63/510,103, titled “ELECTRICAL COMPONENTS FOR SCIENCE, TECHNOLOGY, ENGINEERING, AND MATH CONSTRUCTION SYSTEMS,” filed on Jun. 23, 2023, the entire disclosure of which is hereby incorporated by reference in its entirety.

### FIELD OF THE DISCLOSURE

The present disclosure generally relates to science, technology, engineering, and math (“STEM”) construction systems. More specifically, the present disclosure relates to electrical systems of the STEM construction systems that include simplified couplers for coupling adjacent structures.

### BACKGROUND

STEM construction systems typically seek to foster learning and interest in science, technology, engineering, and math as well as encouraging creativity. In some examples, these systems include one or more electric components which can be used to provide power to the system for performing some action. However, these electrical systems are often analog systems operating within a limited voltage range and with limited communication options. Analog systems have limited power delivery and communications transmission options which in turn limits the design options for performing complex tasks with the kit. Accordingly, it would be beneficial to improve the electrical system to enhance design options and perform more complex tasks.

It is with respect to these and other general considerations that examples have been described. Also, although relatively specific problems have been discussed, it should be understood that the examples should not be limited to solving the specific problems identified in the background.

### SUMMARY

Aspects of the present disclosure relate to a digital electrical system for STEM construction system. In examples, the STEM construction system may consist of one or more electrical components (e.g., power sources and/or one or more bits), and various structural elements such as couplers, trusses, and anchors to support the electrical components. The system may have a power source (e.g., battery) component with a plurality of connection pins, wherein one of the plurality of connection pins is a power detector used for sensing other power sources and communicating the present status of the power source component. Multiple power sources may be used in the system in combination with a power isolator bit that allows the power sources and/or bits to communicate with each other but does not allow current to flow between power sources.

In some examples, the system may use a standard communication method where data is transmitted with units from one electrical component to another. In other examples, the system may utilize proxy communications where one electrical component can function as a proxy for another electrical component in the system by collecting information on the other electrical component in the system, the proxied component, and then acting as a “proxy” of the proxied component by transmitting its data to other requesting components. In some examples, whether standard or proxy communications, the data may be converted to normalized unitless data prior to transmission and be reconverted back to data with units by the electrical component using conversion information following receipt of the normalized unitless data. The conversion information may be transmitted when two bits are connected to each other and then maintained by a bit, such that the conversion information does not need to be continuously transmitted but can be established in a flexible negotiation procedure between bits as part of the communication process. In other examples, the data may be transmitted with units. The electrical components may have default modes and in some instances the default mode can be changed with additional input. The benefits of the digital electrical system are increased efficiency in communication, bi-directional information flow, the ability to operate with flexibly transmitted units and/or normalized unitless data, and greater control of system components via the ability to access complex, hidden, and/or non-default values and settings of bits that otherwise may not be accessible.

This Summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exclusive examples are described with reference to the following figures.

FIGS. 1A-1G are perspective views of electrical components of a STEM system, according to aspects described herein.

FIG. 2 is a block diagram illustrating a method for using the power source sensing pin of the power source, according to aspects described herein.

FIG. 3 is a block diagram illustrating a method for performing proxy communications, according to aspects described herein.

FIG. 4 is a block diagram illustrating a method for using normalized unitless values in an electrical system, according to aspects described herein.

FIG. 5 illustrates a simplified block diagram of a device with which aspects of the present disclosure may be practiced, according to aspects described herein.

### DETAILED DESCRIPTION

In the following detailed description, references are made to the accompanying drawings that form a part hereof, and in which are shown by way of illustrations specific examples or examples. These aspects may be combined, other aspects may be utilized, and structural changes may be made without departing from the present disclosure. Examples may be practiced as methods, systems, or devices. Accordingly, examples may take the form of a hardware implementation, an entirely software implementation, or an implementation combining software and hardware aspects. The following detailed description is therefore not to be taken in a limiting sense, and the scope of the present disclosure is defined by the appended claims and their equivalents.

The STEM system may be provided to a user as a kit—that is, with one or more components of the system detached from each other. The system generally includes a plurality of components including electrical components such as one or more power sources (e.g., a battery), and one or more bits. Bits are components of the electrical system that receive power from the power sources to perform some function. A plurality of components may be bits including, but not limited to, button bits, slider bits, threshold bits (e.g., where if the input to the threshold bit is greater than some threshold value which may be controlled by a knob or other input control mechanism then the system may perform some action or stop some action), a motor bit, distance sensor bit, light emitting diode (LED) bit, brightness indicator bit, data display bit, an inertial measurement unit (IMU) bit, a power isolator bit, and a coding bit which may receive code and provide it to other components of the system, a computer, a robot with user programmable features, among other examples. Bits may have different types and numbers of default settings, inputs, and outputs depending on the features and functions of the bit. Bits may also be programmable, such as a coding bit, for performing a variety of functions in addition to potentially containing fixed firmware. Thus, bits may contain firmware, software, and/or both. For example, an LED may have a default brightness setting even though it may be adjustable via an onboard component and/or adjustable when it is connected to another bit in the system (e.g., a slider bit and/or a coding bit).

Further, bits may have different modes of operation within the system. To change a mode of operation a bit may receive input from a selectable feature on the electrical component (e.g., an onboard switch or button), via a user inputting code to a coding bit, and/or by attaching another electrical component to it. For example, a motor bit may function as both a servo motor and DC motor based on a change in input to the motor bit. In some examples the change in mode input could be made by receiving a button press or a switch flip on the bit itself. In other examples, the change in input could be provided from a separate bit such as a button bit connected to the motor bit to change the direction of drive, servo to DC mode, velocity mode, and/or position mode, among others. In another example, a data display bit could be used to display proxy values of preceding bits in the system 100 such that these values may be selected and modified via the data display bit. For example, if the data display is connected to an IMU whose default mode is acceleration, the user could select angular velocity on the data display to modify the IMU, and/or to provide this value to a subsequent bit connected to the IMU or the data display via a separate port. In a further example an LED bit may have a plurality of LEDs included in the bit. The default mode may be that each LED shines at a consistent intensity indefinitely as long as power is supplied from a power source. In addition to the default mode, the bit may have onboard buttons to select different modes of operation and/or a separate bit such as a button bit and/or data display bit may be attached to control the function of each LED independently such that you could turn each LED on or of individually at random intervals with varying intensity among other examples.

The electrical components may be components having communication ports, proxy components having proxy communication ports, coding components having coding communication ports, and/or if the component has more than one communication port a combination of the three. The component port classification is based on the communication methods utilized by the electrical component at that port, as will be described in greater detail herein. Standard components use a standard communication method, proxy components may perform proxy communications and may function as a proxy for another electrical component, and coding components may be programmable via a coding language. The system may also include a plurality of structural elements such as a plurality of trusses, couplers, retainers, anchors, gears, and/or a plurality of other similar structural elements for supporting the electrical components. The electrical components and structural elements may be connected to each other via a variety of connection means such as snaps, fasteners, and/or connecting apertures integrally formed into the system components themselves. The electrical components may be connected in a sequence to facilitate the performance of some function, such as a battery connected to a data display bit, motor bit, LED bit, and gear to turn a wheel. The electrical components may be supported by one or more structural elements.

The system may be a digital system with voltage and communications throughout the system. The electrical components in the system may utilize a standard, proxy, and/or coding communication methods from one or more ports on the electrical component. Generally, the electrical components communicate from one component to the next, where the components are aware of the components that they are connected to but not the complete sequence of components throughout the system. Thus, components communicate directly from one component to the next and are not able to communicate to other components they are not directly connected to via a port.

The communication flow may be standard, proxy, and/or coding based on the type of ports connected from one electrical component to the next. The determination of what type of communication method to be utilized is determined when the electrical components are initially connected to each other as a negotiation procedure between the components. The connection between components is a negotiation between the two components is what determines the type of communication style utilized, standard, proxy, coding, and/or other type of communication protocol, based on the type of ports connected. In examples, when two standard ports are connected, it is standard communication, when two proxy ports are connected it is proxy communication, and when two coding ports are connected it is coding. In examples where, a standard port is connected to a proxy or a coding port, the connection will be either proxy or coding. In examples, where a proxy port is connected to a coding port, it is variable which communication method will be utilized based on the negotiation between the components. As such, if multiple components are connected in sequence, a first connection could be standard, the next two connections could be proxy, and a fourth connection could be standard, as an example. Other sequences of connections may be employed without departing from the scope of this disclosure. Similarly, an electrical component may have multiple ports such that it may function as standard communication with one component, proxy communication with a second component, and coding communication with a third component. It will be appreciated by one having skill in the art that based on the type of ports and bits utilized in the system a plurality of connections and communication methods may be utilized within the system.

In a standard communication flow where two standard ports are connected, the negotiation procedure would involve the two components communicating relevant data for transmission, confirming they are both standard ports, and then flowing the information back and forth as required where each port provides information directly related to its electrical component. For example, if a motor with a standard port and a battery with a standard port are connected, the standard communication flow from the motor will relate to data associated with the motor and communication from the battery will relate to the battery.

In a proxy communication method, where two proxy ports are connected, the negotiation procedure is similar to the standard communication negotiation of confirming port type, exchanging information, and then functioning in a proxy method. In a proxy method, an electrical component with a proxy port may clone the information provided to it by a previous component in the chain of components, the proxied component, and then transmit the data from the proxied component to a subsequent component requesting the data. Stated differently, the proxy component can impersonate the proxied component to subsequent components in the system. For example, consider three components a motor connected to a proxy port of a data display bit and an LED connected to a proxy port of the data display bit. In this example, the LED is supposed to light up when the motor is on. The data display bit may receive the information from the motor as proxy data then impersonate the motor to the LED by transmitting the motors data to the LED as the motor. This means that the LED is not aware that it isn't communicating with the motor, rather because the proxy port of the data display is communicating the information, the simple processor of the LED thinks it is getting the information directly from the motor and turns on as if it were speaking directly to the motor. The data display, in this scenario functions as the proxy for the proxied motor and can pass on the relevant information to the LED and/or other components it is connected to. Proxying provides the additional benefit of being able to access features of a component that might otherwise not be accessible via direct input and/or direct controls available on the component itself, such as an IMU. In examples, the system may utilize a method of proxy communication between electrical components to further improve communication efficiency and allow external and more advanced control of a component than the user interface of the component may provide.

In a coding communication method, the negotiation procedure is similar to that described above, but in this case, the coding component may receive direct input from a user as a coding language that the coding component may transmit to the subsequent component to control it. If the coding component is connected to a proxy component, such as a data display, the data display may be able to proxy the code from the coding component to a subsequent component.

To facilitate the efficient flow of information, whether utilizing a standard, proxy, or coding communication method, data can be transmitted with units and/or as unitless normalized values which can be converted back to data with units via one or more conversion factors, as will be described further herein. Moreover, because the system is digital, a larger multidimensional data relating to one or more system components can be accessed by other system components and communicated throughout the system directly via a standard port and/or across the system via a proxy port. This means that multiple components may perform complex functions simultaneously. For example, the increased communication capacity enables the use of an IMU bit within the system in addition to other system components which greatly expands the options for system designs from previous analog systems.

The system has fully digital diagnostic features including error detection built in. Error detection may include a command packet with a response packet with error detection built in during digital communications. This may include command types with command IDs and sequence numbers (e.g., private tokens between commands and responses so they can identify each other), command data depending on the type of command sent through the system (e.g., a command for enabling six functions across the system 100 electrical components).

The disclosed aspects may support a plurality of signal types such as sine values, square wave forms, a continuous reading on a sensor, a continuous commanded value for a motor, etc. The value may be a range from a negative value to a positive value (e.g., negative 1 to positive 1, negative 100 to positive 100, etc.) for enhanced bidirectional functioning of electrical components. For example, a speed value for a motor can be passed as a positive value 2.5 degrees/sec to rotate the motor in a first direction. Then, a negative value of negative 1.5 degrees/sec may be passed to rotate the motor in a second direction opposite the first direction at a variable speed. In a further example, an exact brightness level for an LED may be input to the system because the system is digital.

For communication, sensing, and/or power delivery to electrical components of the system have one or more ports that may be either male and/or female ports. Some electrical components may have both a male and female port while other bits have only a male port or only a female port. For example, drive based and/or codeable bits may have a single female port with a defined communication method. In other examples a data display could have ten ports, some male some female, with the three standard ports, 5 proxy ports, and 2 coding ports. It will be appreciated by one having skill in the art that the number of ports, connection form factor, and communication type for a port is variable based on design choices for the system. The system is having bi-directional communication flow between ports. In some examples, certain ports may be optimized for output such that a female port is provided for output and a male port is provided for input on the electrical component. In other examples, the system 100 is designed for bidirectional communication where each port is designed to be fully bi-directional so it may function as both an input and output port. The plurality of lines in the port may provide one or more of power, ground, transmission, receiving, power detection such as sensing one or more power sources, connection detection. The connection detection line provides instantaneous connection detection whenever an electrical component is connected and/or disconnected from the system 100. This means that each electrical component can independently detect other electrical components within the system without the need for polling.

In examples, the system may function with a single power source (e.g., a single battery) or with multiple power sources using a power isolator bit. In a single power source configuration, the single power source is connected to the other electrical components in sequence and provides power to each component. Alternatively, if a power isolator bit is placed between power sources multiple power sources may be connected to the system. The power isolator bit functions to permit the communication flow between electrical components but does not allow power transmission so that different sequences of electrical components may be isolated from a power source.

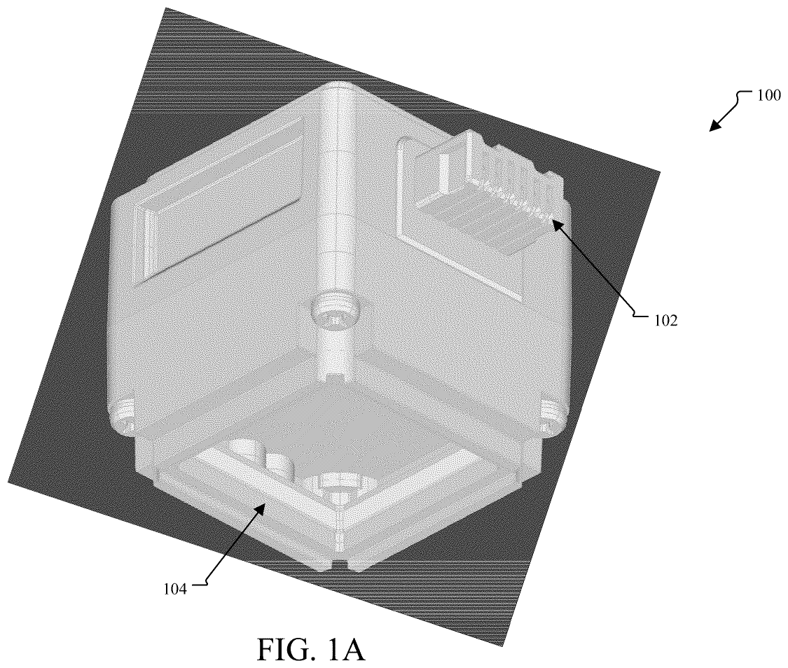

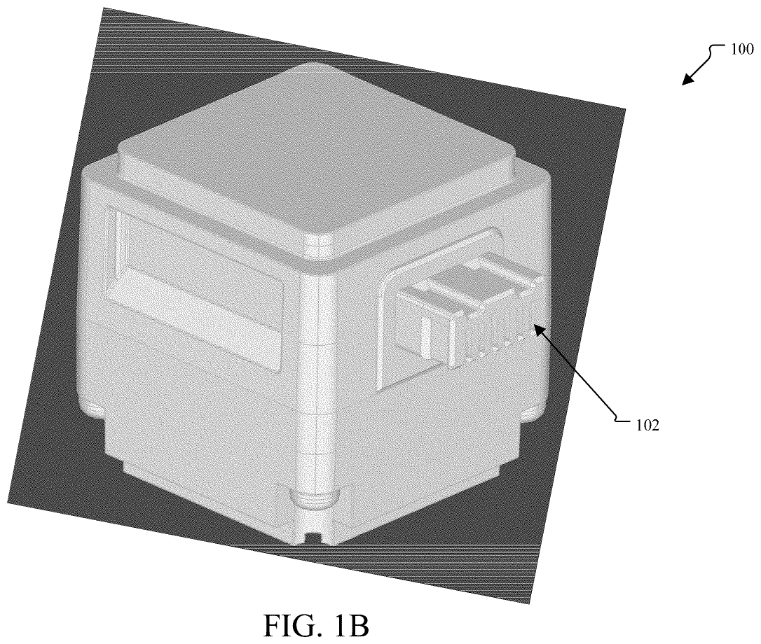

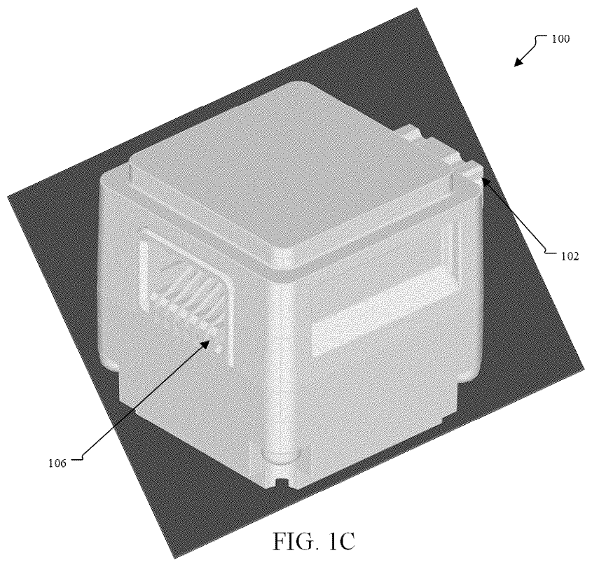

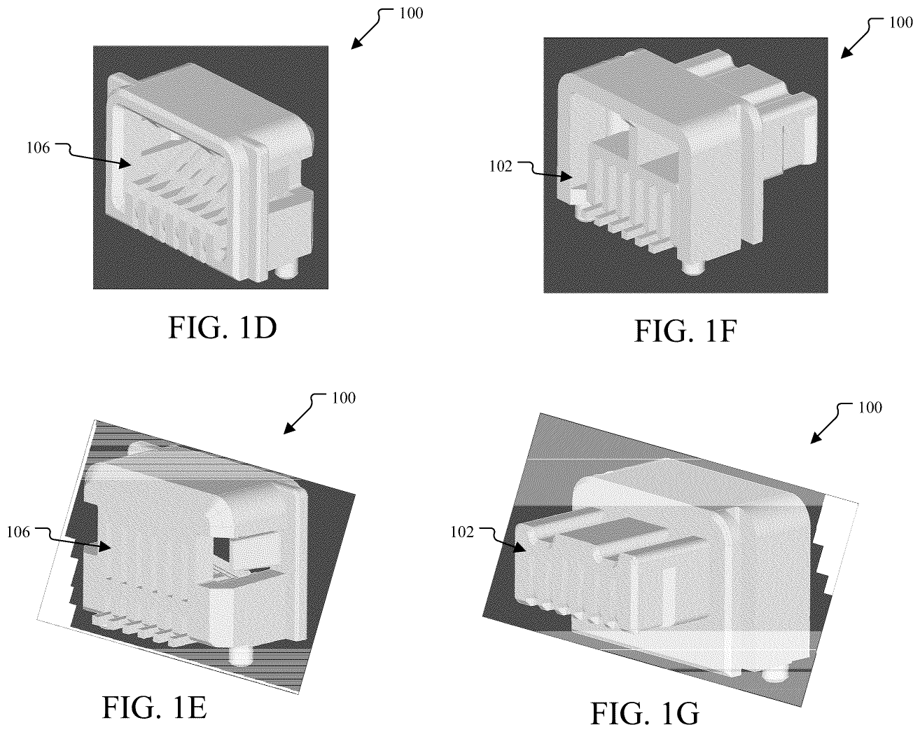

FIGS. 1A-1G are a perspective views of electrical components of the STEM system, according to aspects described herein. It will be appreciated that the electrical component 100 is shown as an electric bit, but the general description of features herein is applicable to the plurality of electrical components. The electrical component 100 also includes a receiving aperture 104 to facilitate detachably coupling to a coupler. Accordingly, the electrical component 100 may be coupled to a truss via a coupler. The electrical component 100 illustratively includes a width of one unit and a length of one unit, however, other shapes for the electrical component may have other widths, lengths, heights, and/or shapes without departing from the scope of this disclosure. Furthermore, other electrical components according to aspects of the present disclosure may have different number and types of ports (e.g., male and/or female ports), different dimensions (for example, 1 unit by 2 units, 1 unit by 3 units, and the like) and, correspondingly, a different number of receiving apertures (for example, two receiving apertures, three receiving apertures, and the like).

Referring again generally to FIGS. 1A-1C and with additional reference to FIGS. 1D-1G, the electrical component 100 also includes a female port 106 and a male port 102, both of which may have a plurality of pins, such as the six-pin ports shown. It will be appreciated by one having skill in the art that the electrical component 100 may have a plurality of ports of different genders based on the design choices for the system. The female port 106 may be connected to the male port of another electrical component (not shown), and the male port 102 may be connected to the female port of yet another electrical component (not shown).

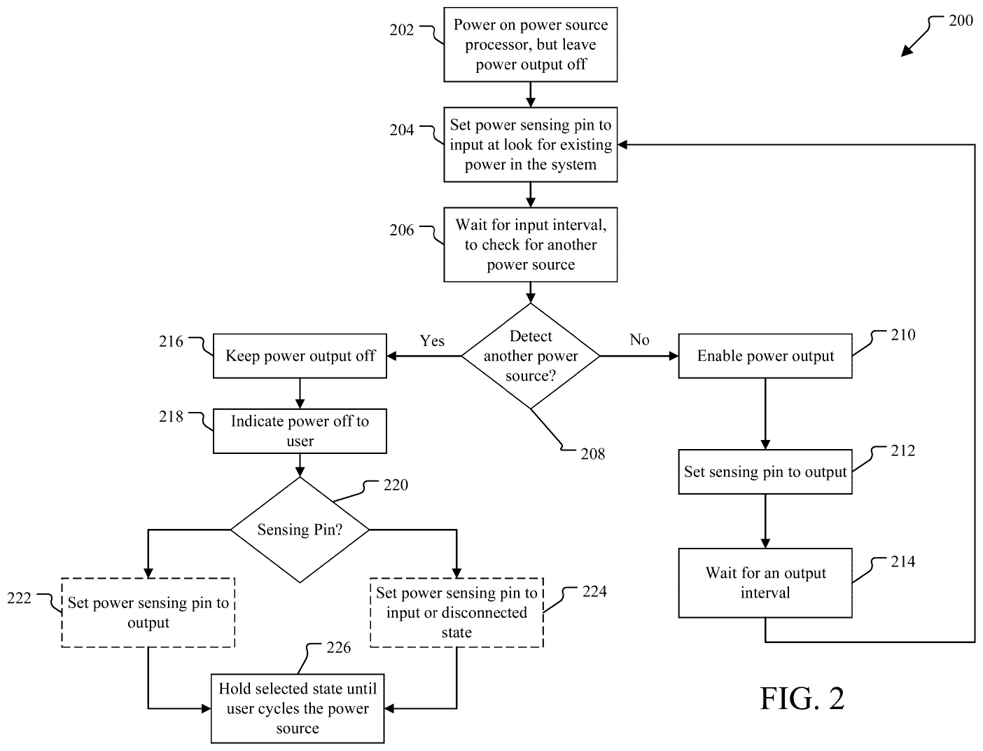

FIG. 2 is a block diagram illustrating a method for using the power source sensing pin of the power source, according to aspects described herein. At operation 202 a power source is connected to the system with the power source processor powered on but the power output off. For each power source, one of the plurality of pins in a port are provided as a power source sensing pin. The sensing pin may be utilized as an input and/or an output pin. As an input pin the sensing pin detect other power sources in the system and may be set to either a high or low state. As an output pin the sensing pin may transmit its status to other power sources in the system. Initially, when a power source is connected to the system, the sensing pin defaults to a state to detect other power sources in the system. The power output remains off until the power source can determine if another power source is connected.

At operation 204, the power sensing pin is set to input to look for existing power sources in the system. The sensing pin would detect another power source if it received a signal from another other power source. The sensing pin may act in addition to the other protection mechanisms included in the system such as current sensing. At operation 206, the power source waits for an input interval to check for another power source. While waiting for the input interval the sensing pin is constantly checking for another source.

At operation 208, it is determined if another power source is detected. Another power source may not be detected for example, because another power source is not connected to the system. Alternatively, one or more power isolator bits may be connected to the system isolating other power supplies from that portion of the system. In the case that a power isolator is connected the sense pin of the power sources are isolated from each other meaning they would not detect each other. If another power source is not detected, flow progresses to operation 210 where power output is enabled to the system from the power source. At operation 212 the sensing pin is set to output so that it is transmitting its status throughout the system. At operation 214, the power source will transmit for an output interval before returning to operation 204 where the sensing pin will transition to input and look for other sources. The interval may be any sequence so long as the sequence fall out of alignment with another power source in some short amount of time thereby enabling the power sources to be in different sensing states (e.g., one in input while the other is in output) and thereby detect each other. Examples of the interval include a randomly generated interval with differing seed values, periodic sequences with differing frequencies, random intervals, etc.

Returning to operation 208, if another power source is detected, meaning a communication from another power source is detected by the sensing pin, flow progresses to operation 216 where the power source keeps the power source turned off so that no power flows to the system. At operation 218, the power source would indicate the power off state to the user. At operation 220, it is determined which state to set the sensing pin to, based on system design choices. In one optional embodiment, at operation 222, the sensing pin is set to output. In this state the power source will eventually force other power sources in the system to shut down because the other power sources will eventually transition to an input state, receive the output transmission and shut down, depowering the system. Alternatively, at optional operation 224 the power sensing pin is set to input or an otherwise disconnected state. In this state, the system will not be depowered as the other power sources will not receive the output transmission and remain powering the system. Both operations 222 and 224 are shown as dashed lines to indicate they are optional. Flow progresses from both operations 222 and 224 to operation 226 where the power source and power sensing pin hold the selected state until the user cycles the power source.

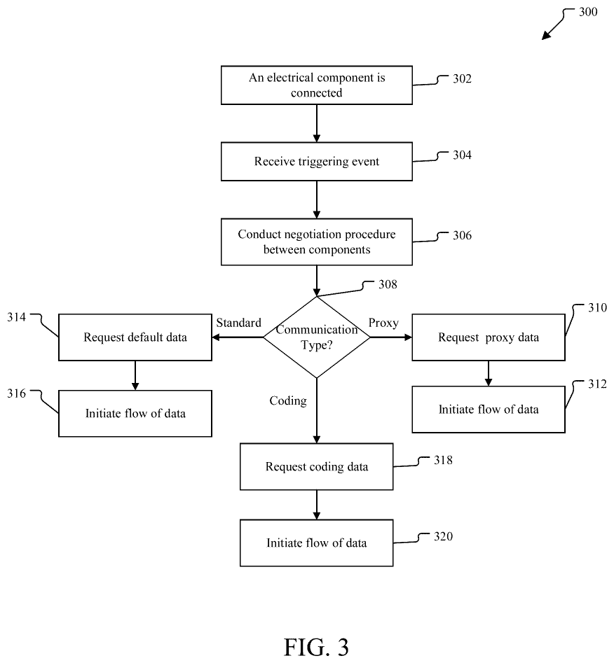

FIG. 3 is a block diagram illustrating a method for performing proxy communications, according to aspects described herein. At operation 302, one or more electrical components are connected to the system. At operation 304, a triggering event is received by the system. A triggering event may be an electrical component is connected to the system, an electrical component is removed from the system, and/or a change in system status occurs (e.g., a command is generated for a component, a value is changed at a display device, etc.) triggering the generation and transmission of data. Once connected, at operation 306 a negotiation procedure is conducted between a first electrical component and a second electrical component. The negotiation procedure includes exchanging communication type (e.g., proxy, standard, or coding) for the connected port and determining which component should control the communication, type of component (e.g., power source or type of bit), what data it transmits and/or receives (e.g., values, units, and/or conversions) and/or what those values are among other information. For example, the second component may have 8 data pins, where 6 are inputs and 2 are outputs. The second bit may also provide the names of the inputs and outputs, their unit labels (e.g., meters/second, degree symbol, etc.) and any conversion information to transform the data to and from a unitless value.

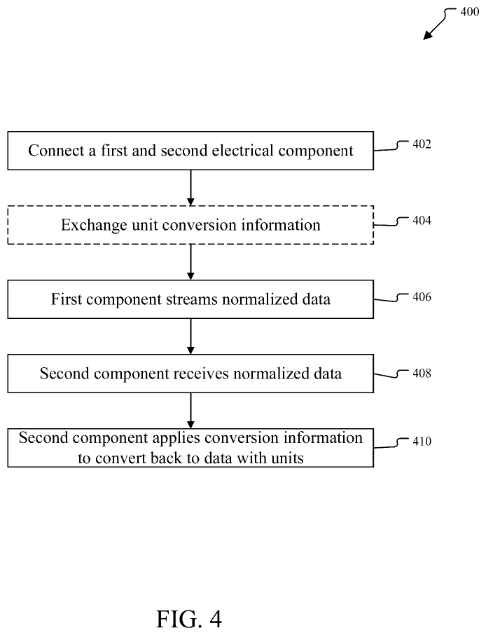

At operation 308 the communication type is determined. If the communication type will be proxy, flow progresses to operation 310 where proxy data is requested. The proxying component request information about the proxied bit values. This may include any number of input and/or output values such as unit conversion, labels, etc. For example, a proxying component may request all values that a subsequent bit could proxy. Flow progresses to operation 312 where the flow of data is initiated from the proxied component to the proxying component and vice versa. The proxying bit may tell the proxied bit to start streaming and to prepare to receive streaming and the proxied bit may begin streaming. In some examples, where a third component is connected to the proxying component the new component would follow the process described in FIG. 4 such as requesting the data that is being proxied and receiving from the proxying component the proxied data. In this example, the proxying component would update the proxied bit on the new component and any requests for additional data. The flow of communication would be bi-directional with components being able to both transmit and receive.

Alternatively, if the communication type at operation 308 is standard, flow progresses to operation 314 where the input component will request information about the output component's default data. This information may or may not include conversion information, labels, etc. Flow progresses to operation 316 where the flow of data is initiated. In some examples, this may include the input component telling the output component to start streaming data. Alternatively, if the communication type at operation 308 is coding, flow progresses to operation 318 where the coding data is requested and at operation 320 the flow of data is initiated. In examples, once data is transmitted between the first electrical component and the second electrical component, the method 300 may be repeated to transfer data between the second electrical component and the third electrical component. That is, the method 300 may be transmitted until the last electrical component receives the data. Alternatively, once the initial negotiation is performed, the data may be transmitted across a plurality of components without having to repeat the operations disclosed in the method 300.

FIG. 4 is a block diagram illustrating a method for using normalized unitless values in an electrical system, according to aspects described herein. At 402, a first and second electrical component are connected. At operation 404, the two components may exchange unit conversion information for any data they may transmit in a normalized unitless state. The components may store the conversion information so that it does not need to be continuously transmitted throughout the system. Regardless of communication method used (standard, proxy, or coding) the data may be transmitted as normalized unitless data as an alternative to transmitting data with units. There are several methods which could be utilized to convert the data with units to unitless data including multiplication of the data with units by some factor, linear interpolation, and transmitting coefficients to a standard equation known by receiving electrical components. In some examples, the normalized data is expressed as a bit based (e.g., 8-bit, 16-bit, 32-bit etc.) fixed-point integer value with bit based fractional information. For example, normalized data could be sent as signed 16-bit fixed point integer values with 14-bits of fractional information. In alternative examples, the normalized data could be transmitted as a Boolean bit, floating number and/or a data array. The benefit of the normalized unitless data is that it enables electrical components with a plurality of data with units to communicate with each other directly.

At operation 406 the first component streams normalized data to the second component. At operation 408, the second component receives the normalized data and at operation 410 applies the conversion information to convert the normalized data back to data with units.

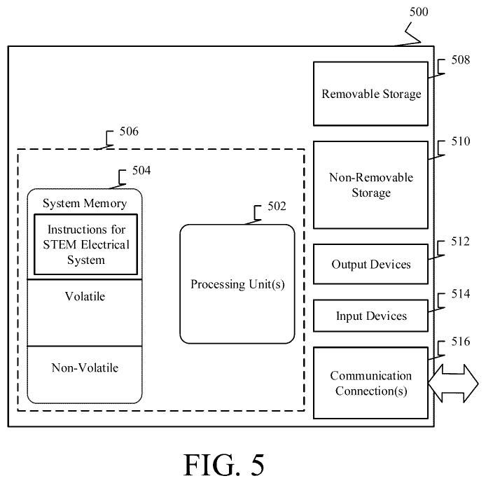

FIG. 5 illustrates a simplified block diagram of a device with which aspects of the present disclosure may be practiced, according to aspects described herein. The device may be a mobile computing device, for example. One or more of the present examples may be implemented in an operating environment 500. This is only one example of a suitable operating environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smartphones, network PCs, minicomputers, mainframe computers, distributed computing environments that include any of the above systems or devices, and the like.

In its most basic configuration, the operating environment 500 typically includes at least one processing unit 502 and memory 504. Depending on the exact configuration and type of computing device, memory 504 (e.g., instructions for STEM electrical system as disclosed herein) may be volatile (such as RAM), non-volatile (such as ROM, flash memory, etc.), or some combination of the two. This most basic configuration is illustrated in FIG. 5 by dashed line 506. Further, the operating environment 500 may also include storage devices (removable, 508, and/or non-removable, 510) including, but not limited to, magnetic or optical disks or tape. Similarly, the operating environment 500 may also have input device(s) 514 such as remote controller, keyboard, mouse, pen, voice input, on-board sensors, etc. and/or output device(s) 512 such as a display, speakers, printer, motors, etc. Also included in the environment may be one or more communication connections 516, such as LAN, WAN, a near-field communications network, a cellular broadband network, point to point, etc.

Operating environment 500 typically includes at least some form of computer readable media. Computer readable media can be any available media that can be accessed by the at least one processing unit 502 or other devices comprising the operating environment. By way of example, and not limitation, computer readable media may comprise computer storage media and communication media. Computer storage media includes volatile and nonvolatile, removable, and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible, non-transitory medium which can be used to store the desired information. Computer storage media does not include communication media. Computer storage media does not include a carrier wave or other propagated or modulated data signal.

Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

The operating environment 500 may be a single computer operating in a networked environment using logical connections to one or more remote computers. The remote computer may be a personal computer, a server, a router, a network PC, a peer device, or other common network node, and typically includes many or all of the elements described above as well as others not so mentioned. The logical connections may include any method supported by available communications media. Such networking environments are commonplace in-offices, enterprise-wide computer networks, intranets, and the Internet.

As will be appreciated, the various methods, devices, apps, nodes, features, etc., described with respect to any of the figures described herein, are not intended to limit the system to being performed by the particular apps and features described. Accordingly, additional configurations may be used to practice the methods and systems herein and/or features and apps described may be excluded without departing from the methods and systems disclosed herein.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use claimed aspects of the disclosure. The claimed disclosure should not be construed as being limited to any aspect, example, or detail provided in this application. Regardless of whether shown and described in combination or separately, the various features (both structural and methodological) are intended to be selectively included or omitted to produce an example with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system comprising:
a power source having a sensing pin;
one or more electrical components;
at least one processor; and
memory storing instructions that, when executed by the at least one processor, cause the system to perform a set of operations, the set of operations comprising:
connecting a power source in sequence with one or more electrical components;
receiving, by the sensing pin, in an input state;
detecting, by the sensing pin, if another power source is connected in sequence;
when another power source is not detected; transmitting, by the sensing pin, in an output state; and
providing, by the power source, power to the one or more electrical components.

2. The system of claim 1, wherein the set of operations further comprises, transitioning, by the sensing pin, between a low state and high state at a random intervals.

3. The system of claim 1, wherein the set of operations further comprises, when another power source is detected, maintaining an off state of the power source.

4. The system of claim 3, wherein the set of operations further comprises, enabling a power of indicator.

5. The system of claim 4, wherein the set of operations further comprises:
transitioning the sensing pin to output, wherein transitioning the sensing pin to output will cause the another power source to shut down.

6. The system of claim 4, wherein the set of operations further comprises setting the sensing pint to an input state to maintain power to the system.

7. A method for communicating data between a plurality of components, the method comprising:
receiving a triggering event;
in response to receiving the triggering event, conducting a negotiation between a first electrical component and a second electrical component, wherein conducting the negotiation comprises exchanging a communication type;
based upon the communication type, initiating flow of data between the first electrical component and the second electrical component; and
upon receiving data at the second electrical component, conducting a second negotiation between the second electrical component and the third electrical component; and
based upon a second communication type, initiating a second flow of data between the second electrical component and the third electrical component.

8. The method of claim 7, wherein when the communication type is a standard communication type, initiating the flow of data comprises:
requesting information about the second component's default data format; and
transmitting data in the default data format to the second electrical component.

9. The method of claim 8, further comprising, in response to requesting the information, receiving conversion information, wherein the conversion information is used to convert the data to the default format.

10. The method of claim 7, wherein when the communication type is a proxy communication type, initiating the flow of data comprises:
connecting the first and second electrical components;
exchanging conversion information between the first electrical component and the second electrical component;
streaming normalized data from the first component to the second component; and
at the second component, converting the normalized data to unit data using the conversion information.

11. The method of claim 10, wherein normalizing the data comprises converting an initial data set comprising unit information to unitless data.

12. The method of claim 11, converting the initial data comprises at least one of multiplying the initial data with units by a factor, linear interpolation, or transmitting coefficients to a standard equation.

13. The method of claim 11, wherein the normalized data a fixed-point integer value.

14. The method of claim 11, wherein the normalized data is formatted as Boolean, a floating number, or a data array.

15. The method of claim 7, wherein when the communication type is a coding communication type, initiating the flow of data comprises transmitting coding data from the first electrical component to the second electrical component, wherein the coding data causes the second electrical component to perform an action.

16. The method of claim 15, wherein the action comprises setting an LED brightness level on the second electrical component.

17. The method of claim 15, wherein the action comprises controlling a motor on the second electrical component.

18. The method of claim 7, wherein the triggering event comprises connecting a new electrical component to the plurality of components.

19. The method of claim 7, wherein the triggering event comprises disconnecting an existing electrical component from the plurality of components.

20. The method of claim 7, wherein the triggering event is a change in status for the plurality of components.
